(19) United States
(12) Patent Application Publication
(10) Pub. No.: US 2013/0222645 A1
(43) Pub. Date: Aug. 29, 2013

(54) MULTI FRAME IMAGE PROCESSING APPARATUS

(71) Applicant: Radu Ciprian Bilcu, Tampere (FI)

(72) Inventor: Radu Ciprian Bilcu, Tampere (FI)

(73) Assignee: NOKIA CORPORATION, Espoo (FI)

(21) Appl. No.: 13/822,780

(22) PCT Filed: Sep. 14, 2010
(86) PCT No.: PCT/IB2010/054138

§ 371 Date: May 8, 2013

(51) Int. Cl. H04N 5/262; G06T 9/00

(52) U.S. Cl. CPC H04N 5/2621; G06T 9/00
USPC 348/239; 382/233

(57) ABSTRACT

An apparatus comprising at least one processor and at least one memory including computer program code the at least one memory and the computer program code configured to, with the at least one processor, cause the apparatus at least to perform: selecting a first image of a subject with a first image capture parameter and at least one further image of substantially the same subject with at least one corresponding further image capture parameter; determining at least one feature match image by matching a feature of the at least further image to a corresponding feature of the first image; generating at least one residual image by subtracting the at least one feature match image from the first image; encoding the first image and the at least one residual image; and combining in a file the encoded reference image, the encoded at least one residual image, and information associated with the matching feature.

### FIELD OF THE APPLICATION

The present application relates to a method and apparatus for multiframe image processing. In some embodiments the method and apparatus relate to image processing and in particular, but not exclusively limited to, multi-frame image processing for portable devices.

### SUMMARY OF THE APPLICATION

Imaging capture devices and cameras are generally known and have been implemented on many electrical devices. Multi-frame imaging is a technique which may be employed by cameras and image capturing devices. Such multi-frame imaging applications are, for example, high or wide dynamic range imaging in which several images of the same scene are captured with different exposure times and then can be combined to a single image with better visual quality. The use of high dynamic range/wide dynamic range applications allow the camera to then filter any intense back light surrounding and on the subject and enhance the ability to distinguish features and shapes on the subject. Thus, for example where light enters a room from various angles, a camera placed on the inside of a room will be able to capture a subject image through the intense sunlight or artificial light entering the room. Traditional single frame images do not provide an acceptable level of performance as they will either produce an image which is too dark to show the subject or the background is washed out by the light entering the room.

Another multi-frame application is multi-frame extended depth of focus or field applications where several images of the same scene are captured with different focus settings. In these applications, the multiple frames can be combined to obtain an output image which is sharp everywhere.

A further multi-frame application is multi-zoom multi-frame applications where several images of the same scene are captured with differing levels of optical zoom. In these applications the multiple frames may be combined to permit the viewer to zoom into an image without suffering from a lack of detail produced in single frame digital zoom operations.

Much effort has been put into attempting to find efficient methods for combining the multiple images into a single output image. However, current approaches preclude later processing which may produce better quality outputs.

The storing of multiple images in original raw data formats although allowing later processing/viewing is problematic in terms of the amount of memory required to store all of the images. Furthermore it is of course possible to encode independently all of the captured images as separate encoded files and thus reduce the ‘size’ of each image and save all of the files. One such encoding system known is the joint photographic experts group JPEG encoding format.

Image storage formats such as JPEG do not exploit the similarities between the series of images which constitute the multi frame image. For instance an image encoding and storage system such may encode and store each image from the multi frame image separately as a single JPEG file. Consequently this can result in an efficient use of memory especially when the multiple images are of the same scene.

However, the images of a multi frame image can vary from one another to some degree, even when the images are captured over the same scene. This variation can be attributed to varying factors such as noise or movement as the series of images are captured. Such variations across a series of images can reduce the efficiency and effectiveness of any multi frame image system which exploits the similarities between images for the purpose of storage.

### SUMMARY OF VARIOUS EXAMPLES

This application therefore proceeds from the consideration that whilst it is desirable to improve the memory efficiency of storing a multi frame image by exploiting similarities or near similarities between the series of captured images, it is also desirable to account for any variation that may exist between the series of captured images in order to improve the effectiveness of the storage system.

According to a first aspect there is provided a method comprising: selecting a first image of a subject with a first image capture parameter and at least one further image of substantially the same subject with at least one corresponding further image capture parameter; determining at least one feature match image by matching a feature of the at least further image to a corresponding feature of the first image; generating at least one residual image by subtracting the at least one feature match image from the first image; encoding the first image and the at least one residual image; and combining in a file the encoded reference image, the encoded at least one residual image, and information associated with the matching feature.

The feature may be a statistical based feature, and wherein matching a feature of the further image to a corresponding feature of the first image may comprise: generating a pixel transformation function for the at least one further image by mapping the statistical based feature of the at least one further image to a corresponding statistical based feature of the first image, such that as a result of the mapping the statistical based feature of the at least one further image has substantially the same value as the corresponding statistical based feature of the first image; and generating the feature match image may further comprise using the pixel transformation function to transform pixel values of the at least one non reference image.

The statistical based feature may be a histogram of pixel level values within an image, wherein the pixel transformation function may transform at least one pixel level value of the further image to a further pixel level value, and wherein the value of the further pixel level value may be associated with the histogram of pixel level values of the first image.

The pixel transformation function may be associated with a direct mapping function between the histogram of the at least one further image and the histogram of the first image.

Information associated with the matching of the feature of the further image to the corresponding feature of the reference image in a file may comprise: parameters associated with the pixel transformation function.

The method may further comprise: geometrically aligning the at least one feature match image to the first image by using an image registration algorithm, wherein the geometrical alignment is performed before subtracting the at least one feature match image from the first image.

Combining the at least one encoded residual image, the encoded first image and the information associated with the matching of the feature of the further image to the corresponding feature of the first image in a file may comprise: logically linking at least the at least one encoded residual image and the at least one further encoded image in the file.

The method may further comprise capturing the first image and the at least one further image.

Capturing the first image and the at least one further image may comprise capturing the first image and the at least one further image within a period, the period being perceived as a single event.

The method may further comprise: selecting an image capture parameter value for each image to be captured.

Each image capture parameter may comprise at least one of: exposure time; focus setting; zoom factor; background flash mode; analogue gain; and exposure value.

The method may further comprise inserting a first indicator in the file indicating at least one of the first image capture parameter and the at least one further image capture parameter.

The method may further comprise inserting at least one indicator in the file indicating a value of at least one of the first image capture parameter and a value of the at least one of the at least further image capture parameter.

Capturing a first image and at least one further image may comprise at least one of: capturing the first image and subsequently capturing each of the at least one further image; and capturing the first image substantially at the same time as capturing each of the at least one further image.

There is provided according to a second aspect an apparatus comprising at least one processor and at least one memory including computer program code the at least one memory and the computer program code configured to, with the at least one processor, cause the apparatus at least to perform: selecting a first image of a subject with a first image capture parameter and at least one further image of substantially the same subject with at least one corresponding further image capture parameter; determining at least one feature match image by matching a feature of the at least further image to a corresponding feature of the first image; generating at least one residual image by subtracting the at least one feature match image from the first image; encoding the first image and the at least one residual image; and combining in a file the encoded reference image, the encoded at least one residual image, and information associated with the matching feature.

The feature may be a statistical based feature, and wherein matching a feature of the further image to a corresponding feature of the first image may cause the apparatus to perform: generating a pixel transformation function for the at least one further image by mapping the statistical based feature of the at least one further image to a corresponding statistical based feature of the first image, such that as a result of the mapping the statistical based feature of the at least one further image has substantially the same value as the corresponding statistical based feature of the first image; and generating the feature match image may further cause the apparatus to perform using the pixel transformation function to transform pixel values of the at least one non reference image.

The statistical based feature may be a histogram of pixel level values within an image, wherein the pixel transformation function may cause the apparatus to perform transforming at least one pixel level value of the further image to a further pixel level value, and wherein the value of the further pixel level value may be associated with the histogram of pixel level values of the first image.

The pixel transformation function may be associated with a direct mapping function between the histogram of the at least one further image and the histogram of the first image.

Information associated with the matching of the feature of the further image to the corresponding feature of the reference image in a file may comprise: parameters associated with the pixel transformation function.

The apparatus may be further caused to perform: geometrically aligning the at least one feature match image to the first image by using an image registration algorithm, wherein the geometrical alignment is performed before subtracting the at least one feature match image from the first image.

Combining the at least one encoded residual image, the encoded first image and the information associated with the matching of the feature of the further image to the corresponding feature of the first image in a file may cause the apparatus to perform: logically linking at least the at least one encoded residual image and the at least one further encoded image in the file.

The apparatus may be further caused to perform capturing the first image and the at least one further image.

Capturing the first image and the at least one further image further may cause the apparatus to perform capturing the first image and the at least one further image within a period, the period being perceived as a single event.

The apparatus may further perform selecting an image capture parameter value for each image to be captured.

Each image capture parameter may comprise at least one of: exposure time; focus setting; zoom factor; background flash mode; analogue gain; and exposure value.

The apparatus may further perform inserting a first indicator in the file indicating at least one of the first image capture parameter and the at least one further image capture parameter.

The apparatus may further perform inserting at least one indicator in the file indicating a value of at least one of the first image capture parameter and a value of the at least one of the at least further image capture parameter.

Capturing a first image and at least one further image may cause the apparatus to further perform at least one of: capturing the first image and subsequently capturing each of the at least one further image; and capturing the first image substantially at the same time as capturing each of the at least one further image.

There is provided according to a third aspect a method comprising: decoding an encoded first image and at least one encoded residual image composed of the encoded difference between the first image and a feature match image, contained in a file, wherein the feature match image is a further image which has been determined by matching a feature of at least one further image to a corresponding feature of the first image; subtracting the at least one decoded residual image from the decoded first image to generate the at least one feature match image; and transforming the at least one feature match image to generate at least one further image.

The first image may be of a subject with a first image capture parameter, and the at least one further image may be substantially the same subject with at least one further image capture parameter.

The feature may be a statistical based feature and a value of the statistical based feature of the at least one feature match image may be substantially the same as a value of the statistical based feature of the first image, and wherein transforming the feature match image may comprise: using a pixel transformation function to transform pixel level values of the at least one feature match image, wherein the transformation function comprises mapping the statistical based feature of the at least one feature match image from the corresponding statistical based feature of the first image, such that the value of the statistical based feature of the at least one feature match image differs from the value of the statistical based feature of the reference image.

The statistical based feature may be a histogram of pixel level values within an image, wherein the pixel transformation function may transform at least one pixel level value of the at least one feature match image to a further pixel level value, and wherein the further pixel level value may be associated with a histogram of pixel level values of the at least one further image.

The pixel transformation function may be associated with an inverse of a mapping function between the histogram of the at least one feature match image and the histogram of the first image.

The file may further comprise the pixel transformation function.

The method may further comprise determining a number of encoded residual images from the file to be decoded, wherein the number of encoded residual images to be decoded may be selected by the user.

All encoded residual images from the file may be decoded.

The method may further comprise selecting the encoded residual images from the file which are to be decoded, wherein the encoded residual images to be decoded may be selected by the user.

There is provided according to a fourth aspect an apparatus comprising at least one processor and at least one memory including computer program code the at least one memory and the computer program code configured to, with the at least one processor, cause the apparatus at least to perform: decoding an encoded first image and at least one encoded residual image composed of the encoded difference between the first image and a feature match image, contained in a file, wherein the feature match image is a further image which has been determined by matching a feature of at least one further image to a corresponding feature of the first image; subtracting the at least one decoded residual image from the decoded first image to generate the at least one feature match image; and transforming the at least one feature match image to generate at least one further image.

The first image may be of a subject with a first image capture parameter, and the at least one further image may be substantially the same subject with at least one further image capture parameter.

The feature may be a statistical based feature and a value of the statistical based feature of the at least one feature match image may be substantially the same as a value of the statistical based feature of the first image, and wherein transforming the feature match image may cause the apparatus to perform: using a pixel transformation function to transform pixel level values of the at least one feature match image, wherein the transformation function comprises mapping the statistical based feature of the at least one feature match image from the corresponding statistical based feature of the first image, such that the value of the statistical based feature of the at least one feature match image differs from the value of the statistical based feature of the reference image.

The statistical based feature may be a histogram of pixel level values within an image, the pixel transformation function may cause the apparatus to transform at least one pixel level value of the at least one feature match image to a further pixel level value, and wherein the further pixel level value may be associated with a histogram of pixel level values of the at least one further image.

The pixel transformation function may be associated with an inverse of a mapping function between the histogram of the at least one feature match image and the histogram of the first image.

The file may further comprise the pixel transformation function.

The apparatus may further be caused to perform: determining a number of encoded residual images from the file to be decoded, wherein the number of encoded residual images to be decoded is selected by the user.

The apparatus may be further caused to perform decoding all encoded residual images from the file.

The apparatus may be further caused to perform selecting by the user the encoded residual images from the file to be decoded.

According to a fifth aspect there is provided an apparatus comprising: an image selector configured to select a first image of a subject with a first image capture parameter and at least one further image of substantially the same subject with at least one corresponding further image capture parameter; a feature match image generator configured to determine at least one feature match image by matching a feature of the at least further image to a corresponding feature of the first image; a residual image generator configured to generate at least one residual image by subtracting the at least one feature match image from the first image; an image encoder configured to encoding the first image and the at least one residual image; and file generator configured to combine in a file the encoded reference image, the encoded at least one residual image, and information associated with the matching feature.

The feature may be a statistical based feature, and wherein feature match image generator configured to match a feature of the further image to a corresponding feature of the first image may comprise: an analyser configured to generate a pixel transformation function for the at least one further image by mapping the statistical based feature of the at least one further image to a corresponding statistical based feature of the first image, such that as a result of the mapping the statistical based feature of the at least one further image has substantially the same value as the corresponding statistical based feature of the first image; and transformer configured use the pixel transformation function to transform pixel values of the at least one non reference image.

The statistical based feature may be a histogram of pixel level values within an image, wherein the transformer may transform at least one pixel level value of the further image to a further pixel level value, and wherein the value of the further pixel level value may be associated with the histogram of pixel level values of the first image.

The pixel transformation function may be associated with a direct mapping function between the histogram of the at least one further image and the histogram of the first image.

Information associated with the matching of the feature of the further image to the corresponding feature of the reference image in a file may comprise: parameters associated with the pixel transformation function.

The apparatus may further comprise: an image aligner configured to geometrically align the at least one feature match image to the first image by using an image registration algorithm, wherein the geometrical alignment is performed before subtracting the at least one feature match image from the first image.

The file generator may comprise a linker configured to logically link at least the at least one encoded residual image and the at least one further encoded image in the file.

The apparatus may further comprise a camera configured to capture the first image and the at least one further image.

The camera may be configured to capture the first image and the at least one further image within a period, the period being perceived as a single event.

The apparatus may further comprise: a capture parameter selector configured to select an image capture parameter value for each image to be captured.

Each image capture parameter may comprise at least one of: exposure time;

focus setting; zoom factor; background flash mode; analogue gain; and exposure value.

The file generator may further be configured to insert a first indicator in the file indicating at least one of the first image capture parameter and the at least one further image capture parameter.

The file generator may further be configured to insert at least one indicator in the file indicating a value of at least one of the first image capture parameter and a value of the at least one of the at least further image capture parameter.

The camera may be configured to capture the first image and subsequently capture each of the at least one further image; and capturing the first image substantially at the same time as capturing each of the at least one further image.

There is provided according to a sixth aspect an apparatus comprising: a decoder configured to decode an encoded first image and at least one encoded residual image composed of the encoded difference between the first image and a feature match image, contained in a file, wherein the feature match image is a further image which has been determined by matching a feature of at least one further image to a corresponding feature of the first image; a feature match image generator configured to subtract the at least one decoded residual image from the decoded first image to generate the at least one feature match image; and a transformer configured to transform the at least one feature match image to generate at least one further image.

The first image may be of a subject with a first image capture parameter, and the at least one further image may be substantially the same subject with at least one further image capture parameter.

The feature may be a statistical based feature and a value of the statistical based feature of the at least one feature match image may be substantially the same as a value of the statistical based feature of the first image.

The transformer may be configured to use a pixel transformation function to transform pixel level values of the at least one feature match image.

The transformer may comprise a mapper configured to map the statistical based feature of the at least one feature match image from the corresponding statistical based feature of the first image, such that the value of the statistical based feature of the at least one feature match image differs from the value of the statistical based feature of the reference image.

The statistical based feature may be a histogram of pixel level values within an image.

The transformer may be configured to transform at least one pixel level value of the at least one feature match image to a further pixel level value, and wherein the further pixel level value may be associated with a histogram of pixel level values of the at least one further image.

The pixel transformation function may be associated with an inverse of a mapping function between the histogram of the at least one feature match image and the histogram of the first image.

The file may further comprise the pixel transformation function.

The apparatus may further comprise an image selector configured to determine a number of encoded residual images from the file to be decoded.

The image selector may be configured to receive a user input to determine the number of encoded residual images.

All encoded residual images from the file may be decoded.

There is provided according to a seventh aspect an apparatus comprising: means for selecting a first image of a subject with a first image capture parameter and at least one further image of substantially the same subject with at least one corresponding further image capture parameter; means for determining at least one feature match image by matching a feature of the at least further image to a corresponding feature of the first image; means for generating at least one residual image by subtracting the at least one feature match image from the first image; means for encoding the first image and the at least one residual image; and means for combining in a file the encoded reference image, the encoded at least one residual image, and information associated with the matching feature.

The feature may be a statistical based feature, and wherein the means for matching a feature of the further image to a corresponding feature of the first image may comprise: means for generating a pixel transformation function for the at least one further image by mapping the statistical based feature of the at least one further image to a corresponding statistical based feature of the first image, such that as a result of the mapping the statistical based feature of the at least one further image has substantially the same value as the corresponding statistical based feature of the first image; and means for generating the feature match image may further cause the apparatus to perform using the pixel transformation function to transform pixel values of the at least one non reference image.

The statistical based feature may be a histogram of pixel level values within an image, wherein the means for generating a pixel transformation function may comprise means for transforming at least one pixel level value of the further image to a further pixel level value, and wherein the value of the further pixel level value may be associated with the histogram of pixel level values of the first image.

The pixel transformation function may be associated with a direct mapping function between the histogram of the at least one further image and the histogram of the first image.

Information associated with the matching of the feature of the further image to the corresponding feature of the reference image in a file may comprise: parameters associated with the pixel transformation function.

The apparatus may further comprise: means for geometrically aligning the at least one feature match image to the first image by using an image registration algorithm, wherein the geometrical alignment is performed before subtracting the at least one feature match image from the first image.

the means for combining in a file the at least one encoded residual image, the encoded first image and the information associated with the matching of the feature of the further image to the corresponding feature of the first image may comprise means for logically linking at least the at least one encoded residual image and the at least one further encoded image in the file.

The apparatus may further comprise means for capturing the first image and the at least one further image.

The means for capturing the first image and the at least one further image further may comprise means for capturing the first image and the at least one further image within a period, the period being perceived as a single event.

The apparatus may further comprise means for selecting an image capture parameter value for each image to be captured.

Each image capture parameter may comprise at least one of: exposure time; focus setting; zoom factor; background flash mode; analogue gain; and exposure value.

The apparatus may further comprise means for inserting a first indicator in the file indicating at least one of the first image capture parameter and the at least one further image capture parameter.

The apparatus may further comprise means for inserting at least one indicator in the file indicating a value of at least one of the first image capture parameter and a value of the at least one of the at least further image capture parameter.

The means for capturing a first image and at least one further image may further comprise means for capturing the first image and subsequently capturing each of the at least one further image.

The means for capturing a first image and at least one further image may further comprise means for capturing the first image substantially at the same time as capturing each of the at least one further image.

There is provided according to an eighth aspect an apparatus comprising: means for decoding an encoded first image and at least one encoded residual image composed of the encoded difference between the first image and a feature match image, contained in a file, wherein the feature match image is a further image which has been determined by matching a feature of at least one further image to a corresponding feature of the first image; means for subtracting the at least one decoded residual image from the decoded first image to generate the at least one feature match image; and means for transforming the at least one feature match image to generate at least one further image.

The first image may be of a subject with a first image capture parameter, and the at least one further image may be substantially the same subject with at least one further image capture parameter.

The feature may be a statistical based feature and a value of the statistical based feature of the at least one feature match image may be substantially the same as a value of the statistical based feature of the first image, and wherein means for transforming the feature match image may comprise means for using a pixel transformation function to transform pixel level values of the at least one feature match image, wherein the transformation function comprises mapping the statistical based feature of the at least one feature match image from the corresponding statistical based feature of the first image, such that the value of the statistical based feature of the at least one feature match image differs from the value of the statistical based feature of the reference image.

The statistical based feature may be a histogram of pixel level values within an image, the means for using pixel transformation function may comprise means for transforming at least one pixel level value of the at least one feature match image to a further pixel level value, and wherein the further pixel level value may be associated with a histogram of pixel level values of the at least one further image.

The means for using the pixel transformation function may be associated with an inverse of a mapping function between the histogram of the at least one feature match image and the histogram of the first image.

The file may further comprise the pixel transformation function.

The apparatus may further comprise: means for determining a number of encoded residual images from the file to be decoded, wherein the number of encoded residual images to be decoded is selected by the user.

The apparatus may be further comprise means for decoding all encoded residual images from the file.

The apparatus may further comprise means for selecting by the user the encoded residual images from the file to be decoded.

An electronic device may comprise apparatus as described above.

A chipset may comprise apparatus as described above.

For a better understanding of the present application and as to how the same may be carried into effect, reference will now be made by way of example to the accompanying drawings in which:

### SUMMARY OF FIGURES

FIG. 1 shows schematically the structure of a compressed image file according to a JPEG file format;

FIG. 2 shows a schematic representation of an apparatus suitable for implementing some example embodiments;

FIG. 3 shows a schematic representation of apparatus according to example embodiments;

FIG. 4 shows a flow diagram of the processes carried out according to some example embodiments;

FIG. 5 shows a flow diagram further detailing some processes carried by some example embodiments;

FIG. 6 shows a schematic representation depicting in further detail apparatus according to some example embodiments;

FIG. 7 shows schematically the structure of a compressed image file according to some example embodiments;

FIG. 8 shows a schematic representation of apparatus according to some example embodiments;

FIG. 9 shows a flow diagram of the process carried out according to some embodiments; and

FIG. 10 shows a schematic representation depicting in further detail apparatus according to some example embodiments.

### EMBODIMENTS OF THE APPLICATION

The application describes apparatus and methods to capture several static images of the same scene and encode them efficiently into one file. The embodiments described hereafter may be utilised in various applications and situations where several images of the same scene are captured and stored. For example, such applications and situations may include capturing two subsequent images, one with flash light and another without, taking several subsequent images with different exposure times, taking several subsequent images with different focuses, taking several subsequent images with different zoom factors, taking several subsequent images with different analogue gains, taking subsequent images with different exposure values. The embodiments as described hereafter store the images in a file in such a manner that existing image viewers may display the reference image and omit the additional images.

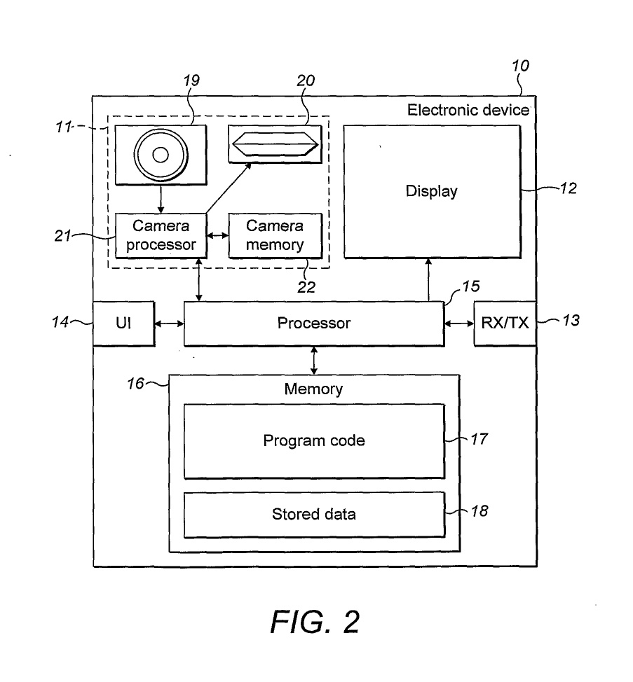

The following describes apparatus and methods for the provision of multi-frame imaging techniques. In this regard reference is first made to FIG. 2 which discloses a schematic block diagram of an exemplary electronic device 10 or apparatus. The electronic device is configured to perform multi-frame imaging techniques according to some embodiments of the application.

The electronic device 10 is in some embodiments a mobile terminal, mobile phone or user equipment for operation in a wireless communication system. In other embodiments, the electronic device is a digital camera.

The electronic device 10 comprises an integrated camera module 11, which is coupled to a processor 15. The processor 15 is further coupled to a display 12. The processor 15 is further coupled to a transceiver (TX/RX) 13, to a user interface (UI) 14 and to a memory 16. In some embodiments, the camera module 11 and/or the display 12 is separate from the electronic device and the processor receives signals from the camera module 11 via the transceiver 13 or another suitable interface.

The processor 15 may be configured to execute various program codes 17. The implemented program codes 17, in some embodiments, comprise image capture digital processing or configuration code. The implemented program codes 17 in some embodiments further comprise additional code for further processing of images. The implemented program codes 17 may in some embodiments be stored for example in the memory 16 for retrieval by the processor 15 whenever needed. The memory 15 in some embodiments may further provide a section 18 for storing data, for example data that has been processed in accordance with the application.

The camera module 11 comprises a camera 19 having a lens for focusing an image on to a digital image capture means such as a charged coupled device (CCD). In other embodiments the digital image capture means may be any suitable image capturing device such as complementary metal oxide semiconductor (CMOS) image sensor. The camera module 11 further comprises a flash lamp 20 for illuminating an object before capturing an image of the object. The flash lamp 20 is coupled to the camera processor 21. The camera 19 is also coupled to a camera processor 21 for processing signals received from the camera. The camera processor 21 is coupled to camera memory 22 which may store program codes for the camera processor 21 to execute when capturing an image. The implemented program codes (not shown) may in some embodiments be stored for example in the camera memory 22 for retrieval by the camera processor 21 whenever needed. In some embodiments the camera processor 21 and the camera memory 22 are implemented within the apparatus 10 processor 15 and memory 16 respectively.

The apparatus 10 may in some embodiments be capable of implementing multi-frame imaging techniques in at least partially in hardware without the need of software or firmware.

The user interface 14 in some embodiments enables a user to input commands to the electronic device 10, for example via a keypad, user operated buttons or switches or by a touch interface on the display 12. One such input command may be to start a multiframe image capture process by for example the pressing of a ‘shutter’ button on the apparatus. Furthermore the user may in some embodiments obtain information from the electronic device 10, for example via the display 12 of the operation of the apparatus 10. For example the user may be informed by the apparatus that a multi frame image capture process is in operation by an appropriate indicator on the display. In some other embodiments the user may be informed of operations by a sound or audio sample via a speaker (not shown), for example the same multi frame image capture operation may be indicated to the user by a simulated sound of a mechanical lens shutter.

The transceiver 13 enables communication with other electronic devices, for example in some embodiments via a wireless communication network.

It is to be understood again that the structure of the electronic device 10 could be supplemented and varied in many ways.

A user of the electronic device 10 may use the camera module 11 for capturing images to be transmitted to some other electronic device or that is to be stored in the data section 18 of the memory 16. A corresponding application in some embodiments may be activated to this end by the user via the user interface 14. This application, which may in some embodiments be run by the processor 15, causes the processor 15 to execute the code stored in the memory 16.

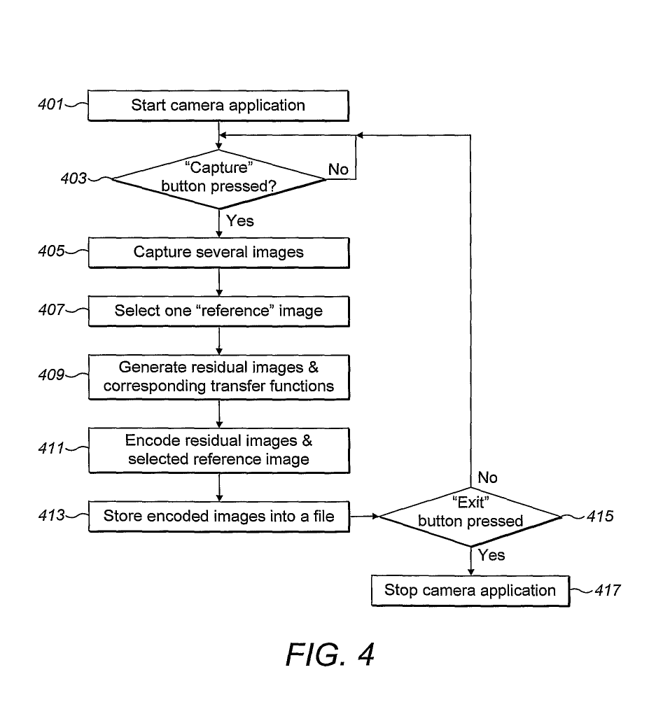

The processor 15 can in some embodiments process the digital image in the same way as described with reference to FIG. 4.

The resulting image can in some embodiments be provided to the transceiver 13 for transmission to another electronic device. Alternatively, the processed digital image could be stored in the data section 18 of the memory 16, for instance for a later transmission or for a later presentation on the display 10 by the same electronic device 10.

The electronic device 10 can in some embodiments also receive digital images from another electronic device via its transceiver 13. In these embodiments, the processor 15 executes the processing program code stored in the memory 16. The processor 15 may then in these embodiments process the received digital images in the same way as described with reference to FIG. 4. Execution of the processing program code to process the received digital images could in some embodiments be triggered as well by an application that has been called by the user via the user interface 14.

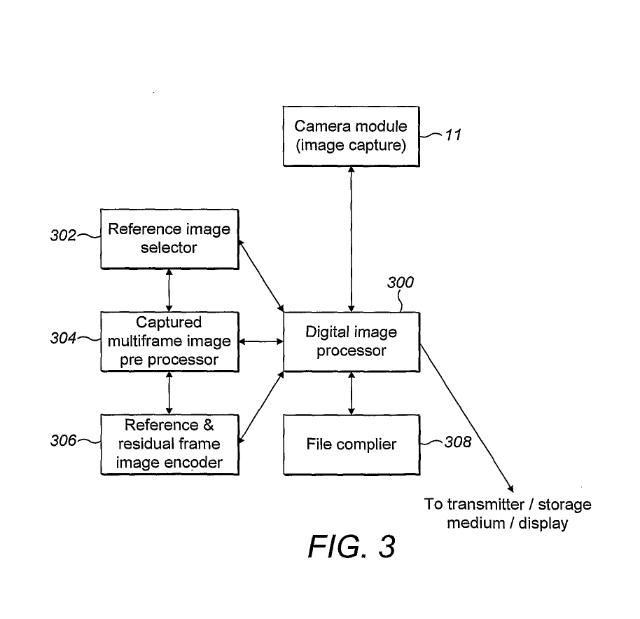

It would be appreciated that the schematic structures described in FIG. 3 and the method steps in FIG. 4 represent only a part of the operation of a complete system comprising some embodiments of the application as shown implemented in the electronic device shown in FIG. 2.

FIG. 3 shows a schematic configuration for a multi-frame digital image processing apparatus according to at least one embodiment. The multi-frame digital image processing apparatus may include a camera module 11, digital image processor 300, a reference image selector 302, a reference image pre processor 304, a residual image generator 306, a reference image and residual image encoder 308 and a file compiler 310.

In some embodiments of the application the multi-frame digital image processing apparatus may comprise some but not all of the above parts. For example in some embodiments the apparatus may comprise only the digital image processor 300, reference image selector 302, multi frame image pre processor 304, and reference and residual frame image encoder 306. In these embodiments the digital image processor 300 may carry out the action of the file compiler 308 and output a processed image to the transmitter/storage medium/display.

In other embodiments of the digital image processor 300 may be the “core” element of the multi-frame digital image processing apparatus and other parts or modules may be added or removed dependent on the current application. In other embodiments, the parts or modules represent processors or parts of a single processor configured to carry out the processes described below, which are located in the same, or different chip sets. Alternatively the digital image processor 300 is configured to carry out all of the processes and FIG. 3 exemplifies the processing and encoding of the multi-frame images.

The operation of the multi-frame digital image processing apparatus parts according to at least one embodiment will be described in further detail with reference to FIG. 4. In the following example the multi-frame image application is a wide-exposure image, in other words where the image is captured with a range of different exposure levels or time. It would be appreciated that any other of the multi-frame digital images as described previously may also be carried using similar processes. Where elements similar to those shown in FIG. 2 are described, the same reference numbers are used.

The camera module 11 may be initialised by the digital image processor 300 in starting a camera application. As has been described previously, the camera application initialisation may be started by the user inputting commands to the electronic device 10, for example via a button or switch or via the user interface 14.

When the camera application is started, the apparatus 10 can start to collect information about the scene and the ambiance. At this stage, the different settings of the camera module 11 can be set automatically if the camera is in the automatic mode of operation. For the example of a wide-exposure multi-frame digital image the camera module 11 and the digital image processor 300 may determine the exposure times of the captured images based on a determination of the image subject. Different analogue gains or different exposure values can be automatically detected by the camera module 11 and the digital image processor 300 in a multiframe mode. Where, the exposure value is the combination of the exposure time and analogue gain.

In wide-focus multi-frame examples the focus setting of the lens can be similarly determined automatically by the camera module 11 and the digital image processor 300. In some embodiments the camera module 11 can have a semi-automatic or manual mode of operation where the user may via the user interface 14 fully or partially choose the camera settings and the range over which the multi-frame image will operate. Examples of such settings that could be modified by the user include a manually focusing, zooming, choosing a flash mode setting for operating the flash 20, selecting an exposure level, selecting an analogue gain, selecting an exposure value, selecting auto white balance, or any of the settings described above.

Furthermore, when the camera application is started, the apparatus 10 for example the camera module 11 and the digital image processor 300 may further automatically determine the number of images or frames that will be captured and the settings used for each images. This determination can in some embodiments be based on information already gathered on the scene and the ambiance. In other embodiments this determination can be based on information from other sensors, such as an imaging sensor, or a positioning sensor capable of locating the position of the apparatus. Examples of such positioning sensor are Global positioning system (GPS) location estimators and cellular communication system location estimators, and accelerometers.

Thus in some embodiments the camera module 11 and the digital image processor 300 can determine the range of exposure levels, and/or a exposure level locus (for example a ‘starting exposure level’, a ‘finish exposure level’ or a ‘mid-point exposure level’) about which the range of exposure levels can be taken for the multi-frame digital image application. In some embodiments the camera module 11 and the digital image processor 300 can determine the range of the analogue gain and/or the analogue gain locus (for instance a ‘starting analogue gain’, a ‘finish analogue gain’ or a ‘mid-point analogue gain’) about which the analogue gain may be set for the multi-frame digital image application. In some embodiments the camera module 11 and the digital image processor 300 can determine the range of the exposure value and/or the exposure value locus (for instance a ‘starting exposure value’, a ‘finish exposure value’ or a ‘mid-point exposure value’) about which the exposure value can be set for the multi-frame digital image application. Similarly in some embodiments in wide-focus multi-frame examples the camera module 11 and the digital image processor 300 can determine the range of focus settings, and/or focus setting locus (for example a ‘starting focus setting, a ‘finish focus setting’ or a ‘mid-point focus setting’) about which the focus setting can be set for the multi-frame digital image application.

In some embodiments, the user may furthermore modify or choose these settings and so can define manually the number of images to be captured and the settings of each of these images or a range defining these images.

The initialisation or starting of the camera application within the camera module 11 is shown in FIG. 4 by the step 401.

The digital image processor 300 in some embodiments can then perform a polling or waiting operation where the processor waits to receive an indication to start capturing images. In some embodiments of the invention, the digital image processor 300 awaits an indicator signal which can be received from a “capture” button. The capture button may be a physical button or switch mounted on the apparatus 10 or may be part of the user interface 14 described previously.

While the digital image processor 300 awaits the indicator signal, the operation stays at the polling step. When the digital image processor 300 receives the indicator signal (following the pressing of the capture button), the digital image processor can communicate to the camera module 11 to start to capture several images dependent on the settings of the camera module as determined in the starting of the camera application operation. The processor in some embodiments can perform an additional delaying of the image capture operation where in some embodiments a timer function is chosen and the processor can communicate to the camera module to start capturing images at the end of timer period.

The polling step of waiting for the capture button to be pressed is shown in FIG. 4 by step 403.

On receiving the signal to begin capturing images from the digital image processor 300, the camera module 11 then captures several images as determined by the previous setting values. In embodiments employing wide-exposure multi-frame image processing the camera module can take several subsequent images of the same or substantially same viewpoint, each frame having a different exposure time or level determined by the exposure time or level settings. For example, the settings may determine that 5 images are to be taken with linearly spaced exposure times starting from a first exposure time and ending with a fifth exposure time. It would be appreciated that embodiments may have any suitable number of images or frames in a group of images. Furthermore, it would be appreciated that the captured image differences may not be linear, for example there may be a logarithmic or other non-linear difference between images.

In a further example, where the camera-flash is the determining factor between image capture frames the camera module 11 may capture two subsequent images, one with flashlight and another without. In a further example the camera module 11 can capture any suitable number of images, each one employing a different flashlight parameter—such as flashlight amplitude, colour, colour temperature, length of flash, inter pulse period between flashes.

In other embodiments where the focus setting is the determining factor between image capture frames the camera module 11 can take several subsequent images with different focus setting. In further embodiments where the zoom factor is the determining factor the camera module 11 can take several subsequent images with different zoom factors (or focal lengths). In further embodiments the camera module 11 can take several subsequent images with different analogue gains or different exposure values. Furthermore in some embodiments the subsequent images captured can differ using one or more of the above factors.

In some embodiments the camera module 11, rather than taking subsequent images, in other words serially capturing images one after another can capture multiple images substantially at the same time using a first image capture arrangement to capture a first image with a first setting exposure time, and a second capture arrangement to capture substantially the same image with a different exposure time. In some embodiments, more than two capture arrangements can be used with an image with a different exposure time being captured by each capture arrangement. Each capture arrangement can be a separate camera module 11 or can in some embodiments be a separate sensor in the same camera module 11.

In other embodiments the different capture arrangements can use the same physical camera module 11 but can be generated from processing the output from the capture device. In these embodiments the optical sensor such as the CCD or CMOS can be sampled and the results processed to build up a series of ‘image frames’. For example the sampled outputs from the sensors can be combined to produce a range of values faster than would be possible by taking sequential images with the different determining factors. For example in wide-exposure multi-frame processing three different exposure frames can be captured by taking a first image sample output after a first period to obtain a first image after a first exposure time, a second or further image sample output a second period after the first period to obtain a second image with a second exposure time and adding the first image sample output to the second image sample output to generate a third image sample output with a third exposure time approximately equal to the first and second exposure time combined.

Therefore in summary at least one embodiment can comprise means for capturing a first image of a subject with a first image capture parameter and at least one further image of substantially the same subject with at least one corresponding further image capture parameter,

The camera module 11 may then pass the captured image data to the digital image processor 300 for all of the captured image frame data.

The operation of capturing multi-frame images is shown in FIG. 4 by step 405.

The digital image processor 300 in some embodiments can pass the captured image data to the reference image selector 302 where the reference image selector 302 can be configured to select a reference image from the plurality of images captured.

In some embodiments, the reference image selector 302 determines an estimate of the image visual quality of each image and the image with the best visual quality is selected as the reference. In some embodiments, the reference image selector may determine the image visual quality to be based on the image having a central part in focus. In other embodiments, the reference image selector 302 selects the reference image as the image according to any suitable metrics or parameter associated with the image. In some embodiments the reference image selector 302 selects one of the images dependent on receiving a user input via the user interface 14. In other embodiments the reference image selector 302 performs a first filtering of the images based on some metric or parameter of the images and then the user selects one of the remaining images as the reference image.

These manual or semi-automatic reference image selections in some embodiments are carried out where the digital image processor 300 displays a range of the captured images to the user via the display 12 and the user selects one of the images by any suitable selection means. Examples of selection means may be in the form of the user interface 14 in terms of a touch screen, keypad, button or switch.

Therefore in summary at least one embodiment can comprise means for selecting a reference image and at least one non reference image from the first captured image and at least one further captured image.

The reference image selection is shown in FIG. 4 by step 407.

The digital image processor 300 then sends the selected reference image together with the series of non-reference frame images to the multi frame image pre processor 304.

It is to be noted hereinafter that the term non reference image refers to any image other than the selected reference image which has been captured by a single iteration of the processing step 405.

It is also to be noted hereinafter that the set of non-reference images refers to the set of all images other than the selected reference image which are captured at a single iteration of the processing step 405.

In some embodiments the multi frame image pre processor 304 can be configured to use the selected reference image as a basis in order to determine a residual image for each of the non-reference images.

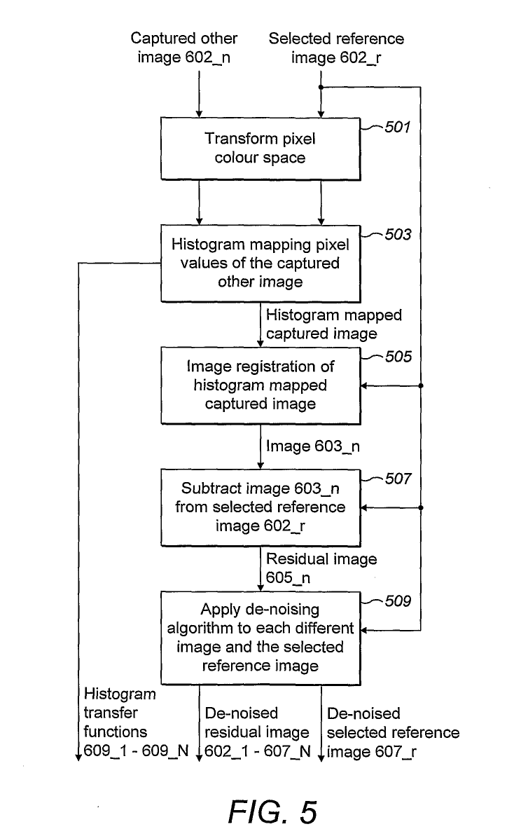

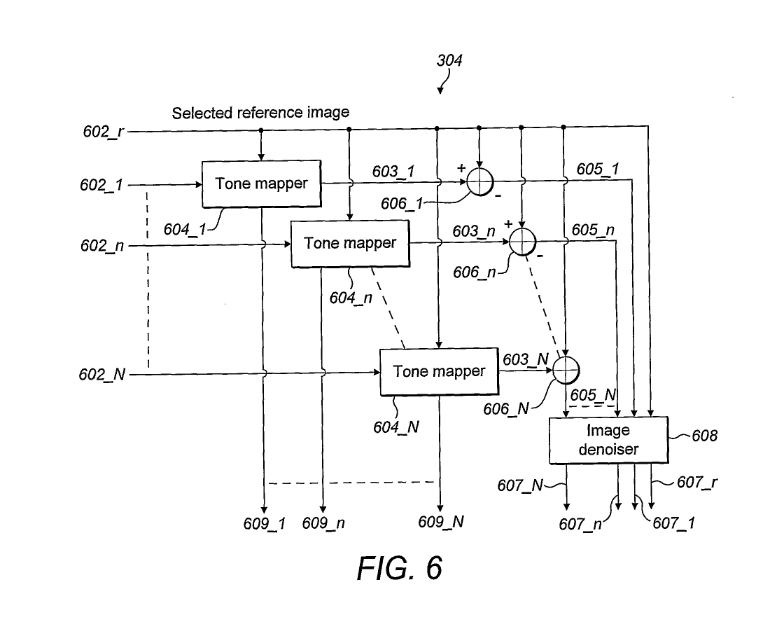

The operation of the multi frame image pre processor 304 will hereafter be described in more detail by reference to the processing steps in FIG. 5 and the block diagram in FIG. 6 depicting schematically the multi frame image pre processor 304 according to some embodiments.

With reference to FIG. 6, the multi frame image pre processor 304 is depicted as receiving a plurality of captured multi frame images (including the selected reference image) via a plurality of inputs, with each of the plurality of inputs being assigned to a particular captured multi frame image. For instance, FIG. 6 depicts that the selected reference image is received on the input 602_{—}r and the non-reference images are each assigned to one of the plurality of inputs 602_1 to 602_N, where N denotes the number of captured other images.

With further reference to FIG. 6, it is to be noted that the input 602_{—}n denotes the general case of a non-reference image.

In some embodiments each of the plurality of inputs 602_1 to 602_N can each be connected to one of a plurality of tone mappers 604_1 to 604_N. In other words, a non reference image received on the input 602_{—}n can be connected to a corresponding tone mapper 604_{—}n. It is to be understood in some embodiments that each non reference image 602_1 to 602_N can be connected to a corresponding tone mapper 604_1 to 604_N.

In some embodiments each tone mapper can perform a mapping process on a non reference image whereby features of the non reference image may be matched to the selected reference image. In other words, a particular tone mapper can be individually configured to perform the function of transforming features from a non-reference image, such that the transformed features exhibit similar properties and characteristics to corresponding features in the selected reference image.

With reference to FIG. 6, the tone mapper 604_{—}n can be arranged to perform a transformation on the non-reference image 602_{—}n.

In order to assist in the understanding of embodiments, the functionality of a tone mapper 604_{—}n will hereafter be described with reference to single non-reference image 602_{—}n and the selected reference image 602_{—}r. However, it is to be understood in embodiments that the method described below can be applied to any pairing of an input non-reference image (602_1 to 602_N) and the selected reference image 602_{—}r

Initially, the tone mapper 604_{—}n may perform a colour space transformation on the pixels of both the input non-reference image 602_{—}n and the selected reference image 602_{—}r. For example, in the first group of embodiments the tone mapper 604_{—}n can transform the Red Green Blue (RGB) pixels of the input non-reference image 602_{—}n into a luminance (or intensity) and chrominance colour space such as the YUV colour space.

In other embodiments the tone mapper 604_{—}n can transform the pixels of the non-reference image 602_{—}n into a different luminance and chrominance colour spaces. For example other luminance and chrominance colour spaces may comprise YIQ, YDbDr or xvYCC colour spaces.

The step of transforming the colour space of the pixels from both the non-reference image 602_{—}n and the selected reference image 602_{—}r is depicted as processing step 501 in FIG. 5.

Furthermore, the processing step of 501 can be implemented as a routine of executable software instructions which can be executed on a processing unit such as that shown as 15 in FIG. 2.

In some embodiments the process of mapping the non-reference image 602_{—}n to the selected reference image 602_{—}r can be performed over one of the components of the transformed colour space. For example, in a first group of embodiments the tone mapper 604_{—}n can be arranged to perform the mapping process over the intensity component for each pixel value.

In some embodiments the mapping process performed by the tone mapper 604_{—}n may be based on a histogram matching method, in which the histogram of the Y component pixel values of the non-reference image 602_{—}n can be modified to match as near as possible to the histogram of the Y component pixel values of the selected reference image 602_{—}r. In other words intensity component pixel values of the non-reference image 602_{—}n are modified so that the histograms of the non-reference image 602_{—}n and the selected reference image 602_{—}r exhibit similar characteristics.

Alternatively this may be viewed in some embodiments, as matching the probability density function (PDF) of component pixel values of the non-reference image 602_{—}n to the PDF of the component pixel values of the selected reference image 602_{—}r.

The histogram matching process can be realized in some embodiments by initially equalizing the component pixel levels of the non-reference image 602_{—}n. This equalizing step can be performed by transforming the component pixel levels of the non-reference other image 602_{—}n with a transformation function derived from the cumulative distribution function (CDF) of the component pixel levels within the non-reference image 602_{—}n.

The above equalizing step can be expressed in some embodiments as

s=T(r)=∫₀^{r}pᵣ(w)dw,

where s represents a transformed pixel value, T(r) represents the transformation function for transforming the pixel level value r of the captured image 602_{—}n, and pᵣ denotes the PDF of the pixel level value r for the captured other image. It is to be appreciated in the above expression that the CDF is given as the integral of the PDF over the dummy variable w.

Additionally, the component pixel values of the selected reference image 602_{—}r, can also be equalised. As above, this equalizing step can also be expressed in some embodiments as an integration step.

For example, the equalising step may be expressed as

v=G(z)=∫₀^{z}p_{z}(w)dw,

where as before v represents a transformed pixel value of the selected reference image 602_{—}r, G(z) represents the function of transforming the pixel level value z of the selected reference image 602_{—}r, and p_{z} denotes the PDF of the pixel level value z for the selected reference image 602_{—}r. Again, it is to be appreciated in the above expression that the CDF in the above expression is given as the integral of the PDF for the dummy variable w.

According to some embodiments, histogram mapping can take the form of transforming a pixel level value s of the captured image 602_{—}n to a desired pixel level value, z, the PDF of which can be associated with the PDF of the selected reference image 602_{—}r by the following transformation

z=G⁻¹(T(r))

It is to be appreciated that the above transformation can be realized in some embodiments by the steps of: firstly equalizing the pixel levels of the captured other image 602_{—}n using the above transformation T(r); determining the transformation function G(z) which equalizes the histogram of pixel levels from the selected reference image 602_{—}r; and then applying the inverse transformation function, z (s), to the previously equalized pixel levels of the captured other image 602_{—}n.

In some embodiments the above integrations may be approximated by summations. For example, the integral to obtain the transformation function T(r) can be implemented in some embodiments as

$$T ( r ) = {\sum }_{i = 1}^{r} \frac{n ( i )}{n} ,$$

where n(i) denotes the number of pixels with a pixel level i, and n represents the total number of pixels in the captured image 602_{—}n.

It is to be appreciated in some embodiments that a transformed pixel level, z, may be quantized to the nearest pixel level.

Other embodiments can deploy a direct method of mapping between histograms rather than the multiple step approach as outlined above. In these embodiments a pixel level of the non-reference image 602_{—}n can be mapped directly as a single step into new pixel level with the desired histogram of the selected reference image 602_{—}r.

The direct method of mapping between histograms can be formed by adopting the approach of minimising the difference between the cumulative histogram of the non-reference image 602_{—}n and the cumulative histogram of the selected reference image 602_{—}r for a particular pixel level of the non-reference image 602_{—}n.

In one group of embodiments the above direct method of histogram mapping a pixel level i from the non-reference image 602_{—}n to a new pixel level j of the selected reference image 602_{—}r can be realised by minimising the following quantity subject to j

$$\vert {\sum }_{k = 0}^{i} {H}_{n} ( k ) - {\sum }_{k = 0}^{j} {H}_{r} ( k ) \vert ,$$

where Hₙ(k) denotes the histogram of the non-reference image 602_{—}n and Hᵣ(k) denotes the histogram of the selected reference image 602_{—}r. The cumulative histograms for the non-reference image 602_{—}n and selected reference image 602_{—}r are calculated as the sum of the histogram values over the number of pixel levels 1 to i and 1 to j respectively, where j is selected to minimise the above expression for a particular value of i.

In other words, the new value of the non-reference image pixel level value i can be determined to be the value of j which minimises the above expression for the difference in cumulative histograms.

In some embodiments the above direct approach to histogram mapping can be implemented in the form of an algorithm in which a mapping table is generated for the range of pixel level values present in the captured other image 602_{—}n. In other words, for each pixel level value i in the range of non-reference image pixel level values 0≦i≦N−1, a new pixel level value j can be determined which satisfies the above condition.

It is to be understood therefore that in the above direct approach each pixel level value i requires just a single determination of the cumulative histogram

$${\sum }_{k = 0}^{i} {H}_{n} ( k ) ,$$

whereas the determination of the cumulative histogram for the selected reference image

$${\sum }_{k = 0}^{j} {H}_{r} ( k )$$

is calculated a number of times until the value of j which minimises the above condition is found.

It is to be further understood that once a mapping table has been generated for the range of pixel level values within the non-reference image 602_{—}n, each pixel value of the non-reference image 602_{—}n can then be mapped to a corresponding value j by simply selecting the table entry index for the pixel level i.

It is to be appreciated for the above expression that the summations used in the determination of the cumulative histogram of the selected reference image 602_{—}r incrementally increases for an iteration of the pixel level j. Therefore in some embodiments, the above algorithm can be implemented such that the summation for the previous calculation of j may be used as a basis upon which the calculation of the subsequent value of j is determined. In other words providing the value of j increases monotonically the value of the cumulative histogram for the j+1 iteration can be formed by taking the previous summation for the j^{th} iteration,

$${\sum }_{k = 0}^{j} {H}_{r} ( k ) ,$$

and then summing the contribution of the histogram at the j+1^{th} iteration, Hᵣ(j+1).

It is to be further appreciated that the above technique of building a mapping table for the range of pixel levels in the captured other image 602_1 may equally be adopted for embodiments adopting the multiple step approach to histogram mapping.

Therefore in summary at least one embodiment comprises means for generating a pixel transformation function for the at least one non reference image by mapping the statistical based feature of the at least one non reference image to a corresponding statistical based feature of the reference image, such that as a result of the mapping the statistical based feature of the at least one non reference image has substantially the same value as the corresponding statistical based feature of the reference image; and means for using the pixel transformation function to transform pixel values of the at least one non reference image.

In some embodiments the histogram mapping step can be applied to only the intensity component (Y) of the pixels of the non-reference image 602_{—}n of the YUV colour space.

In these embodiments, pixel values of the other two components of the YUV colour space, namely the chrominance components (U and V), can be modified in light of the histogram mapping function applied to the intensity (Y) component.

In some embodiments, the modification of the chrominance components (U and V) for each pixel value of the non-reference image 602_{—}n can take the form of scaling each chrominance component by the ratio of the intensity component after histogram mapping to the intensity component before histogram mapping.

Accordingly, scaling of the chrominance components (U and V) for each pixel value of the non-reference image 602_{—}n can be expressed in the first group of embodiments as:

$${U}_{map} = U * \frac{{Y}_{map}}{Y} , and$$

$${V}_{map} = V * \frac{{Y}_{map}}{Y} ,$$

where Yₘₐₚ denotes the histogram mapped luminance component of a particular pixel of the non-reference image 602_{—}n, Y denotes the luminance component for the particular pixel of the non-reference image 602_{—}n, U and V denotes the chrominance component values for the particular pixel value of the non-reference image 602_{—}n.

It is to be understood for other groups of embodiments the above step of mapping the histogram of the non-reference image to the selected reference image can be applied separately to each component of a pixel colour space.

For example in groups of embodiments deploying the YUV colour space, the above described technique of histogram mapping can be applied separately to each of the Y, U and V components.

The step of changing pixel values of the non-reference other image 602_{—}n such that the histogram of the pixel values maps to the histogram of the pixel values of the selected reference image 602_{—}r is depicted as processing step 503 in FIG. 5.

Furthermore, the processing step of 503 can be implemented as a routine of executable software instructions which can be executed within a processing unit such as that shown as 15 in FIG. 2.

With reference to FIG. 6, the output from the tone mapper 602_{—}n can be termed as feature matched non reference image 603_{—}n. In other words the image 603_{—}n is the non-reference image 602_{—}n which has been transformed on a per pixel basis by mapping the histogram of the non-reference image to that of the histogram of the selected reference image 602_{—}r.

As stated previously the above described histogram mapping step may be applied individually to each non-reference image 602_1 to 602_N, in which pixels of each non-reference image 602_1 to 602_N can be transformed by mapping the histogram of each non-reference other image 602_1 to 602_N to that of the histogram of the selected reference image 602_{—}r.

With reference to FIG. 6, the histogram mapping of each non-reference image 602_1 to 602_N to the selected reference image 602_{—}r is shown as being performed by a plurality of individual tone mappers 604_1 to 604_N.

With further reference to FIG. 6, the output from a tone mapper 604_{—}n is depicted as comprising a feature matched non-reference image 603_{—}n, and a corresponding histogram transfer function 609_{—}n.

Therefore in summary at least one embodiment can comprise means for determining at least one featured matched non reference image by matching a feature of the at least one non reference image to a corresponding feature of the reference image.

In some embodiments image registration can be applied to each of the feature matched non-reference mages 603_1 to 603_N before the difference images 605_1 to 605_N are formed. In these embodiments an image registration algorithm can be individually configured to geometrically align each a feature matched non-reference image 603_1 to 603_N to the selected reference image 602_{—}r. In other words, each a feature matched non-reference 603_{—}n can be geometrically aligned to the selected reference image 602_{—}r by the means of an individually configured registration algorithm.

In some embodiments the image registration algorithm can comprise initially a feature detection step whereby salient and distinctive objects such as closed boundary regions, edges, contours and corners are automatically detected in the selected reference image 602_{—}r.

In some embodiments the feature detection step can be followed by a feature matching step whereby the features detected in the selected reference and feature matched non-reference images can be matched. This can be accomplished by finding a pairwise correspondence between features of the selected reference image 602_{—}r and features of the feature matched non-reference image 602_{—}n by, in which the features can be dependent on spatial relations or descriptors.

For example, methods based primarily on spatial relations of the features may be applied if the detected features are either ambiguous or their neighborhoods are locally distorted. It is known from the art that clustering techniques may be used to match such features. One such example may be found in a paper by G, Stockman, S Kopstein and S. Benett in the IEEE Transactions on Pattern Analysis and Machine Intelligence, 1982, pages 229-241, the paper being entitled Matching images to models for registration and object detection via clustering.

Other examples may use the correspondence of features, in which features from the captured and reference images are paired according to the most similar invariant feature descriptions. The choice of the type of invariant descriptor may depend on the feature characteristics and the assumed geometric deformation of the images. Typically the most promising matching feature pairs between the referenced image and the feature matched non-reference image may be performed using a minimum distance rule algorithm. Other implementations in the art may use a different criterion to find the most promising matching feature pairs such as object matching by means of matching likelihood coefficients.

Once feature correspondence has been established by the previous step a mapping function can then be determined which can overlay a feature matched non-reference image 603_{—}n to the selected reference image 602_{—}r. In other words, the mapping function can utilise the corresponding feature pairs to align the feature matched non-reference image 603_{—}n to that of the selected reference image 602_{—}r.

Implementations of the mapping function may comprise at least a similarity transform consisting of rotations, translations and scaling between a pair of corresponding features.

Other implementations of the mapping function known from the art may adopt more sophisticated algorithms such as an affine transform which can map a parallelogram into a square. This particular mapping function is able to preserve straight lines and straight line parallelism.

Further implementations of the mapping function may be based upon radial basis functions which are a linear combination of a translated radial symmetric function with a low degree polynomial. One of the most commonly used radial basis functions in the art is the thin plate spline technique. A comprehensive treatment of thin plate spline based registration of images can be found in the paper by Kohr, entitled Landmark-Based Image Analysis: Using Geometric and Intensity Models, as published in volume 21 of the Computational Imaging and Vision series.

It is to be understood in embodiments that image registration can be applied for each pairing of a histogram mapped captured image 603_{—}n and the selected reference image 602_{—}r.

It is to be further understood that any particular image registration algorithm can be either integrated as part of the functionality of a tone mapper 604_{—}n, or as a separate post processing stage to that of the tone mapper 604_{—}n.

It is to be noted that FIG. 6 depicts image registration as being integral to the functionality of the tone mapper 604_{—}n, and as such the tone mapper 604_{—}n will first perform the histogram mapping function which will then be followed by image registration.

Therefore in summary embodiments can comprise means for geometrically aligning the at least one feature matched non reference image to the reference image by using an image registration algorithm, wherein the geometrical alignment is performed before subtracting the at least one feature matched non reference image from the reference image.

The step of applying image registration to the pixels of the histogram mapped captured image is depicted as processing step 505 in FIG. 5.

Furthermore, the processing step of 505 may be implemented as a routine of executable software instructions which may be executed within a processing unit such as that shown as 15 in FIG. 2.

With reference to FIG. 6 the output from each tone mapper 604_{—}n can be connected to a corresponding subtractor 606_{—}n, whereby each feature matched non reference image 603_{—}n can be subtracted from the selected reference image 602_{—}r in order to form a residual image 605_{—}n.

It is to be appreciated in some embodiments that a residual image 605_{—}n may be determined for all input non-reference images 602_1 to 602_N, thereby generating a plurality of residual images 605_1 to 605_N with each residual image 605_{—}n corresponding to particular input non-reference image 602_{—}n to the captured multiframe image pre processor 304.

It is to be further appreciated in some embodiments that each residual image 605_{—}n can be generated with respect to the selected reference image 602_{—}r.

In some embodiments a residual image 605_{—}n can be generated on a per pixel basis by subtracting a pixel of the histogram mapped captured image 603_{—}n from a corresponding pixel of the selected reference image 602z.

Therefore in summary embodiments can comprise means for generating at least one residual image by subtracting the at least one feature matched non reference image from the reference image.

The step of determining the residual image 605_{—}n is depicted as processing step 507 in FIG. 5.

Furthermore, the processing step of 507 can be implemented as a routine of executable software instructions which can be executed within a processing unit such as that shown as 15 in FIG. 2.

With reference to FIG. 6 the output from each of the N subtractors 606_1 to 606_N are connected to the input of an image denoiser 608. Further, the image de-noiser 608 can also be arranged to receive the selected reference image 602_{—}r as a further input.

The image de-noiser 608 can be configured to perform any suitable image de-noising algorithm which eradicates noise from each of the input residual images 605_1 to 605_N and the selected reference image 602_{—}r.

In some embodiments the de-noising algorithm as operated by the image de-noiser 608 may be based on finding a solution to the inverse of a degradation model. In other words, the de-noising algorithm may be based on a degradation model which approximates the statistical processes which may cause the image to degrade. It is to be appreciated that it is the inverse solution to the degradation model which may be used as a filtering function to eradicate at least in part some of the noise in the residual image.

It is to be further appreciated in the art that there are a number of image de-noising methods which utilise degradation based modelling and therefore can be used in the image de-noiser 608. For example, any one of the following methods may be used in the image de-noiser 608; Non local means algorithm, Gaussian smoothing, Total variation, or Neighbourhood filters.

Other embodiments may deploy image de-noising prior to generating the residual image 605_{—}n. In these embodiments image de-noising may be performed on the selected reference image 602_{—}r prior to entering the subtractors 606_1 to 606_N, and also on the image output from each tone mapper 604_1 to 604_N.

The step of applying a de-noising algorithm to the selected reference image 602_{—}r and to each of the residual images 605_1 to 605_N is depicted as processing step 509 in FIG. 5.

Furthermore, the processing step of 509 can be implemented as a routine of executable software instructions which can be executed within a processing unit such as that shown as 15 in FIG. 2.

With reference to FIG. 6, the output from the image de-noiser 608 can comprise the de-noised residual images 607_1 to 607_N and the de-noised selected reference image 607_{—}r.

With further reference to FIG. 6, the output from the captured multiframe image pre processor 304 is depicted as comprising; the de-noised residual images 607_1 to 607_N, the de-noised residual images' corresponding histogram transfer functions 609_1 to 609_N, and the de-noised selected reference image 607_{—}r.

The step of generating the de-noised residual images 607_1 to 607_N together with their corresponding histogram transfer functions 609_1 to 609_N is depicted as processing step 409 in FIG. 4.

It is to be understood in other embodiments the processing step of applying a de-noising algorithm to the selected reference image 602_{—}r and the series of residual signals 605_1 to 605_N need not be applied.

The image pre processor 304 can be configured to output the de-noised selected reference signal 602_{—}r, and the series of de-noised residual signals together with their respective histogram transfer functions to the digital image processor 300.

The digital image processor 300 then sends the selected reference image and the series of residual images to the image encoder 306 where the image encoder may perform any suitable algorithm on both the selected reference image and the series of residual images in order to generate an encoded reference image and a series of individually encoded residual images. In some embodiments the image encoder 306 performs a standard JPEG encoding on both the reference image and the series of residual images with the JPEG encoding parameters being determined either automatically, semi-automatically or manually by the user. The encoded reference image together with the encoded series of residual images may in some embodiments be passed back to the digital image processor 300.

Therefore in summary at least one embodiment can comprise means for encoding the reference image and the at least one residual image.

The step of encoding the residual images and the selected reference image is shown in FIG. 4 as processing step 411.

The digital image processor 300 may then pass the encoded image files to the file compiler 308. The file compiler 308 on receiving the encoded reference image and the encoded series of residual images compiles the respective images into a single file so that an existing file viewer can still decode and render the referenced image.

Furthermore the digital image processor 300 may also pass the histogram transfer functions associated with each of the encoded residual images in order that they may also be incorporated into the single file.

Thus in some embodiments the file compiler 308 may compile the file so that the reference image is encoded as a standard JPEG picture and the encoded residual images together with their respective histogram transfer functions are added as exchangeable image file format (EXIF) data or extra data in the same file.

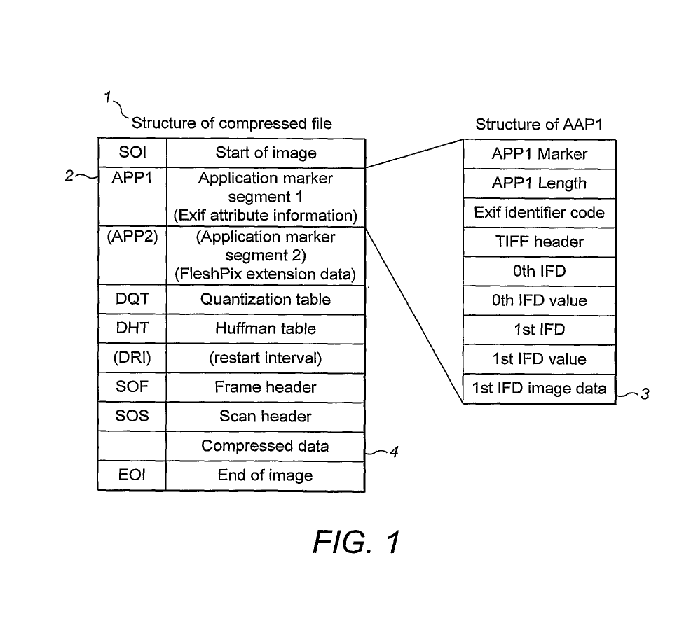

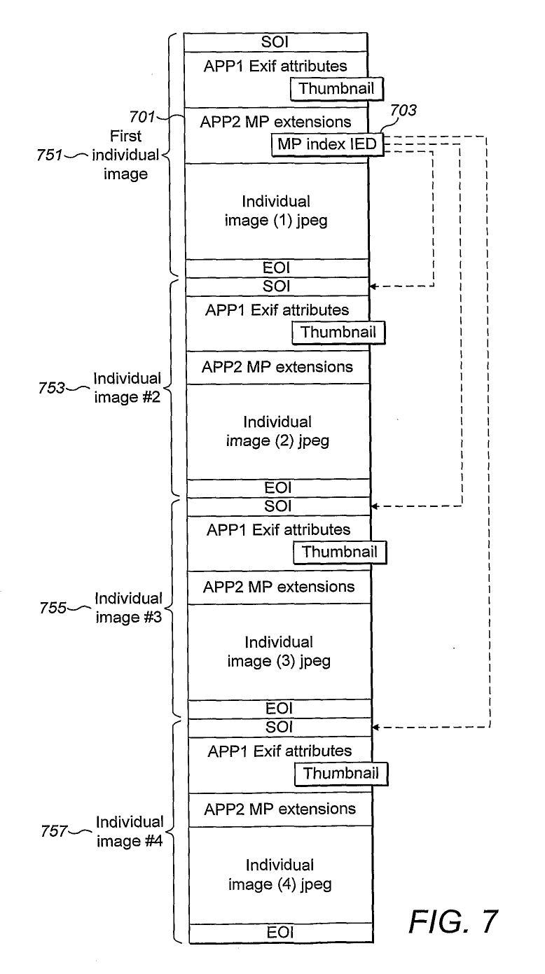

The file compiler may in some embodiments compile a file where the encoded residual images and respective histogram transfer functions are located as a second or further image file directory (IFD) field of the EXIF information part of the file which as shown in FIG. 1 may be part of a first application data field (APP1) of the JPEG file structure. In other embodiments the file compiler 308 may compile a single file so that the encoded residual images and respective histogram transfer functions are stored in the file as an additional application segment, for example an application segment with a designation APP3. In other embodiments the file compiler 308 may compile a multi-picture (MP) file formatted according to the CIPA DC-007-2009 standard by the Camera & Image Products Association (CIPA). A MP file comprises multiple images (First individual image) 751, (Individual image #2) 753, (individual image #3) 755, (individual image #4) 757, each formatted according to JPEG and EXIF standards, and concatenated into the same file. The application data field APP2 701 of the first image 751 in the file contains a multi-picture index field (MP Index IFD) 703 that can be used for accessing the other images in the same file as indicated in FIG. 7. The file compiler 308 may in some embodiments set the Representative Image Flag in the multi-picture index field to 1 for the reference image and to 0 for the non-reference images. The file compiler 308 furthermore may in some embodiments set the MP Type Code value to indicate a Multi-Frame Image and the respective sub-type to indicate the camera setting characterizing the difference of the images stored in the same file, i.e. the sub-type may be one of exposure time, focus setting, zoom factor, flashlight mode, analogue gain, and exposure value.

The file compiler 308 may in some embodiments compile two files. A first file may be formatted according to JPEG and EXIF standards and comprise one of the plurality of images captured, which may be the selected reference image or the image with the estimated best visual quality. The first file can be decoded with legacy JPEG and EXIF compatible decoders. A second file may be formatted according to an extension of JPEG and/or EXIF standards and comprise the plurality of encoded residual images together with there respective histogram transformation functions. The second file may be formatted in a way to enable the file to be not decoded with a legacy JPEG and EXIF compatible decoders. In other embodiments, the file compiler 308 may compile a file for each of the plurality of images captured. The files may be formatted according to JPEG and EXIF standards.

In those embodiments where the file complier 308 compiles at least two files from the plurality of images captured, it may further link the files logically and/or encapsulate them into the same container file. In some embodiments the file compiler 308 may name the at least two files in such a manner that the file names differ only by extension and one file has .jpg extension and is therefore capable of being processed by legacy JPEG and EXIF compatible decoders. The files therefore may form a DCF object according to “Design rule for Camera File system” specification by Japan Electronics and Information Technology Industries Association (JEITA).

Therefore in summary at least one embodiment can comprise means for logically linking at least one encoded residual image and the at least one further encoded image in a file.

In various embodiments the file compiler 308 may generate or dedicate a new value of the compression tag for the coded images. The compression tag is one of the header fields included in the Application Marker Segment 1 (APP1) of JPEG files. The compression tag typically indicates the decompression algorithm that should be used to reconstruct a decoded image from the compressed image stored in the file. The compression tag of the encoded reference image may in some embodiments be set to indicate a JPEG compression/decompression algorithm. However, as JPEG decoding may not be sufficient for correct reconstruction of the encoded residual image or images, a distinct or separate value of the compression tag may be used for the encoded residual images.

In these embodiments a standard JPEG decoder may then detect or ‘see’ only one image, the encoded reference image, which has been encoded according to conventional JPEG standards. Any decoders supporting these embodiments will ‘see’ and be able to decode the encoded residual images as well as the encoded reference image.

Therefore in summary at least one embodiment can comprise means for combining in a file the encoded reference image, the encoded at least one residual image, and information associated with the matching of the feature of the at least one non reference image to the corresponding feature of the reference image.

The compiling of the selected reference and residual images into a single file operation is shown in FIG. 4 by step 413.

The digital image processor 300 may then determine whether or not the camera application is to be exited, for example, by detecting a pressing of an exit button on the user interface for the camera application. If the processor 300 detects that the exit button has been pressed then the processor stops the camera application, however if the exit button has not been detected as being pressed, the processor passes back to the operation of polling for a image capture signal.

The polling for an exit camera application indication is shown in FIG. 4 by step 415.

The stopping of the camera application is shown in FIG. 4 by operation 417.

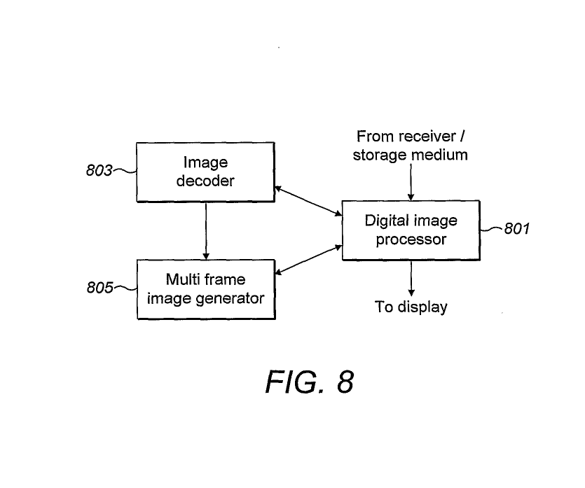

An apparatus for decoding a file according to some embodiments is schematically depicted in FIG. 8. The apparatus comprises a processor 801, an image decoder 803 and a multi frame image generator 805. In some embodiments, the parts or modules represent processors or parts of a single processor configured to carry out the processes described below, which are located in the same, or different chip sets. Alternatively the processor 801 can be configured to carry out all of the processes and FIG. 8 exemplifies the processing and decoding of the multi-frame images.

The processor 801 can receive the encoded file from a receiver or recording medium. In some embodiments the encoded file can be received from another device while in other embodiments the encoded file can be received by the processor 801 from the same apparatus or device, for instance when the encoded file is stored in the device that contains the processor. In some embodiments, the processor 801 passes the encoded file to the image decoder 803. The reference image decoder 803 decodes the selected reference image and any accompanying residual images that may be associated with the selected reference image from the encoded file.

The processor 801 can arrange for the image decoder 803 to pass both the decoded selected reference image and at least one decoded residual image to the multi frame image generator 805. The passing of both decoded selected reference image and at least one decoded residual image may particularly occur when the processor 801 is tasked with decoding an encoded file comprising a multi frame image.

On other modes of operation the processor 801 can arrange for the image decoder 803 to just decode a selected reference image. This mode of operation may be pursued if either the encoded file only comprises a decodable selected reference image, or that the user has selected to view the encoded image as a single frame.

In some embodiments and in some modes of operation the multi frame image generator 805 receives from the image decoder both the decoded selected reference image and at least one accompanying decoded residual image. Further, the multi frame image generator can be arranged to receive from the processor 801 at least one histogram transfer function which is associated with the at least one accompanying decoded residual image. Decoding of the multi frame images accompanying the selected reference image can then take place within the multi frame image generator 805.

In some other embodiments, the decoding of the reference and of the residual images is carried out at least partially in the processor 801.

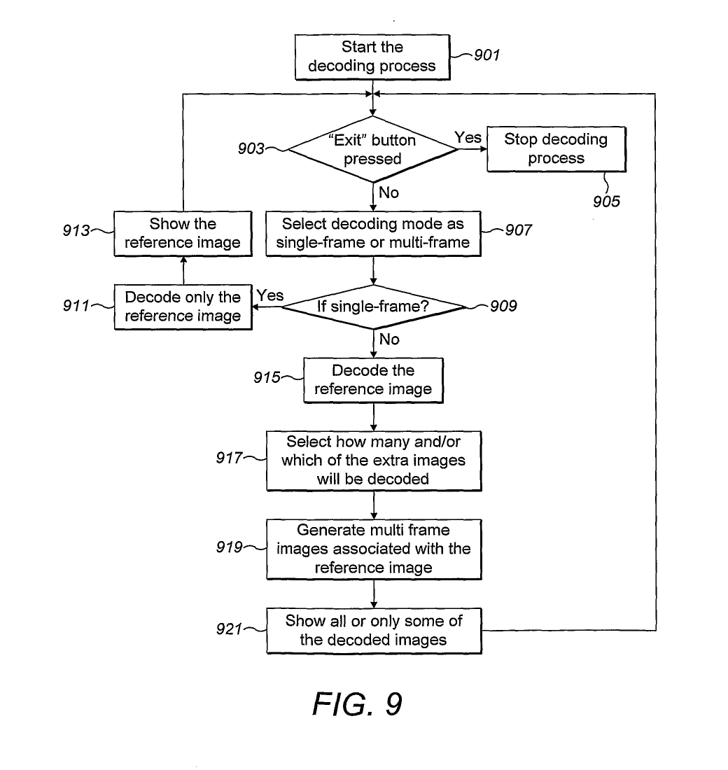

The operation of decoding a multi-frame encoded file according to some embodiments of the application is described schematically with reference to FIG. 9. The decoding process of the multi-frame encoded file may be started by the processor 801 for example when a user switches to the file in an image viewer or gallery application. The operation of starting decoding is shown in FIG. 9 by step 901.

The decoding process may be stopped by the processor 801 for example by pressing an “Exit” button or by exiting the image viewer or gallery application. The polling of the “Exit” button to determine if it has been pressed is shown in FIG. 6 by step 903. If the “Exit” button has been pressed the decoding operation passes to the stop decoding operation as shown in FIG. 9 by step 905.

According to this figure, when the decoding process is started and if the “Exit” button is not pressed (or if the decoding process is not stopped by any other means) the first operation is to select the decoding mode. The selection of the decoding mode according to some embodiments is the selection of decoding in either single-frame or multi-frame mode. In some embodiments, the mode selection can be done automatically based on the number of images stored in the encoded file, i.e., if the file comprises multiple images, a multi-frame decoding mode is used. In some other embodiments, the capturing parameters of various images stored in the file may be examined and the image having capturing parameter values that are estimated to suit user preferences (adjustable for example through a user interface (UI)), capabilities of the viewing device or application, and/or viewing conditions, such as the amount of ambient light, is selected for decoding. For example, if the file is indicated to contain two images and also contains an indication that the two images are intended for displaying on a stereoscopic display device, but the viewing device only is a conventional monoscopic (two-dimensional) display, the processor 801 may determine that a single-frame decoding mode is used. In another example, a file comprises two images differing may have an indicator which indicates that the images differ in their exposure time. An image with the longer exposure time, hence a bright picture compared to the image with the shorter exposure time, may be selected by the processor 801 for viewing when there is a large amount of ambient light detected by the viewing device. In such an example the processor may, if the image selected for decoding is the reference image, select the single-frame decoding mode; otherwise, the processor may select the multi-frame decoding mode is used. In other embodiments the selection of the mode is done by the user for instance through a user interface (UI). The selection of the mode of decoding is shown in FIG. 9 by step 907.

If the selected mode is single-frame then only the selected reference image is decoded and shown on the display. The determination of whether the decoding is single or multi-frame is shown in FIG. 9 by step 909. The decoding of only the selected reference image is shown in FIG. 9 by step 911. The showing or displaying of only the selected reference image is shown in FIG. 9 by step 913.

Therefore in summary at least one embodiment can comprise means for determining a number of encoded residual images from a file to be decoded, wherein the number of encoded residual images to be decoded is selected by a user, and wherein the encoded residual images to be decoded may also be selected by the user

If the selected mode is multi-frame, the reference image and at least one residual image are decoded. The decoding of the reference image as the first image to be decoded for the multi-frame decoding operation is shown in FIG. 9 by step 915. In some embodiments the number of residual images that are extracted from the encoded file can be automatically selected by the image decoder 805 while in some other embodiments this number can be selected by the user through an appropriate UI. In some other embodiments the residual images to be decoded together with the reference image can be selected manually by the user through an UI. The selection of the number and which of the images are to be decoded is shown in FIG. 9 by step 917.

In some embodiments, the decoding of the encoded residual and encoded selected reference images comprises the operation of identifying the compression type used for generating the encoded images. The operation of identification of the compression type used for the encoded images may comprise interpreting a respective indicator stored in the file.

In a first group of embodiments the encoded residual and encoded selected reference images may be decoded using a JPEG decompression algorithm.

The processing step of decoding the encoded residual image may be performed either for each encoded residual image within the file or for a sub set of encoded residual images as determined by the user in processing step 917

Therefore in summary at least one embodiment can comprise means for decoding an encoded reference image and at least one encoded residual image, wherein the encoded reference image and the at least one encoded residual image are contained in a file and wherein the at least one encoded residual image is composed of the encoded difference between a reference image and a feature matched non reference image, wherein the feature matched non reference image is a non reference image which has been determined by matching a feature of the non reference image to a corresponding feature of the reference image.

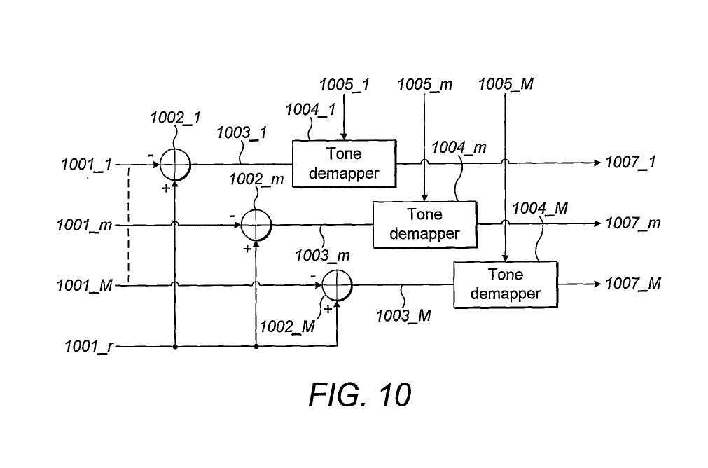

FIG. 10 shows the multi frame image generator 805 in further detail.

With reference to FIG. 10, the multi frame image generator 805 is depicted as receiving a plurality of input images from the image decoder 803. In some embodiments the plurality of input images can comprise the decoded selected reference image 1001_{—}r and a number of decoded residual images 1001_1 to 1001_M.

With reference to FIG. 10, the number of decoded residual images entering the multi frame image generator is shown as images 1001_1 to 1001_M, where M denotes the total number of images. It is to be appreciated that M can be less than or equal to the number of captured other images N, and that the number M can be determined by the user as part of the processing step 917. Furthermore, it is to be understood that a general decoded residual image which can have any image number between 1 to M is generally represented in FIG. 10 as 1001_{—}m.

The multi frame image generator 805 is also depicted in FIG. 10 as receiving a further input 1005 from the digital image processor 801. The further input 1005 can comprise a number of histogram transfer functions, with each histogram transfer function being associated with a particular decoded residual image.

A decoded feature matched non reference image can be recovered from a decoded residual image 1001_{—}m in the multi frame image generator 805 by initially passing the decoded residual image 1001_{—}m to one input of a subtractor 1002_{—}m. The other input to the subtractor 1002_{—}m being configured to receive the decoded selected reference image 1001_{—}r. In total FIG. 10 depicts there being M subtractors one for each input decoded residual image 1001_1 to 1001_M.

Each subtractor 1002_{—}m can be arranged to subtract the decoded residual image 1001_{—}m from the decoded selected reference image 1001_{—}r to produce a decoded feature matched non reference image 1003_{—}m.

In some embodiments the decoded feature matched non reference image 1003m can be obtained by subtracting the decoded residual image from the decoded selected reference image on a per pixel basis.

Therefore in summary at least one embodiment can comprise means for generating the at least one feature matched non reference image by subtracting the at least one decoded residual image from the decoded reference image.

FIG. 10 depicts the output of each subtractor 1002_1 to 1002_M as being coupled to a corresponding tone demapper 1004_1 to 1004_M. Additionally each tone demapper 1004_1 to 1004_M can receive as a further input the respective histogram transfer function corresponding to the decoded feature matched non reference image. This is depicted in FIG. 10 as a series of inputs 1005_1 to 1005_M, with each input histogram transfer function being assigned to a particular tone demapper. In other words a tone mapper 1004_{—}m which is arranged to process the decoded feature matched non reference image 1003_{—}m is assigned a corresponding histogram transfer function 1005_{—}m as input.

The tone demapper 1005m can then apply the inverse of the histogram transfer function to the input decoded feature matched non reference image 1003_{—}m, in order to obtain the multi frame non reference image 1007_{—}m.

According to some embodiments the application of the inverse of the histogram transfer function may be realised by applying the inverse of the histogram transfer function to one of the colour space components for each pixel of the decoded feature matched non reference image 1003_{—}m.

Therefore in summary at least one embodiment can comprise means for generating at least one multi frame non reference image by transforming the at least one decoded feature matched non reference image, wherein the at least one multi frame non reference image and the reference image each correspond to one of either a first image having been captured of a subject with a first image capture parameter or a at least one further image having been captured of substantially the same subject with at least one further image capture parameter.

In such embodiments the other colour space components for each pixel may be obtained by appropriately scaling the other colour space components by a suitable scaling ratio.

For example in a first group of embodiments in which the histogram mapping has been applied to image pixels in the YUV colour space, the luminance component for a particular image 1003_{—}m may have been obtained by using the above outlined inverse histogram mapping process. In this group of embodiments the other two chrominance components for each pixel in the image may be determined by scaling both chrominance components (U and V) by the ratio of the value of the intensity component after inverse histogram mapping to the value of the intensity component before inverse mapping has taken place.

Accordingly in the first group of embodiments, scaling of the chrominance components (U and V) for each pixel value of the multi frame non reference image 1007_{—}m may be expressed as:

$${U}_{invmap} = {U}_{map} * \frac{{Y}_{invmap}}{{Y}_{map}} , and$$

$${V}_{invmap} = {V}_{map} * \frac{{Y}_{invmap}}{{Y}_{map}} ,$$

where Yₘₐₚ denotes the histogram mapped luminance component of a particular pixel of a decoded feature matched non reference image 1003_{—}m, Yᵢₙᵥₘₐₚ denotes the inverse histogram mapped luminance component for the particular pixel of the multi frame non reference image 1007_{—}m. In other words the luminance component of the multi frame non reference image 1007_{—}m, Uₘₐₚ and denotes the histogram mapped chrominance component values for the particular pixel value of the decoded feature matched non reference image 1003_{—}m, Uᵢₙᵥₘₐₚ and Vᵢₙᵥₘₐₚ represents the chrominance components of the multi frame non reference image 1007_{—}m.

Furthermore, it is to be understood that some embodiments may perform a colour space transformation on the multi frame non reference image 1007_{—}m. For example, in embodiments where images have been processed in the YUV colour space a tone demapper 1004_{—}m may perform a colour space transformation such that the multi frame non reference image 1007_{—}m is transformed to the RGB colour space.

The colour space transformation may be performed for each multi frame non reference image 1007_1 to 1007_M.

The step of generating the multi frame non reference images associated with a selected reference image is shown as processing step 919 in FIG. 9.

With reference to FIG. 10, the output of the multi frame image generator is shown as comprising M multi frame non reference images 1007_1 to 1007_M, where as stated before M may be determined to be either the total number of encoded residual images contained within the encoded file, or a number representing a sub set of the encoded residual images as determined by the user in processing step 917.

It is to be appreciated in embodiments that the multi frame non reference images 1007_1 to 1007_M form the output of the multi frame image generator 805.

In some embodiments, after the reference and the selected residual images have been decoded at least one of them may be shown on the display and the decoding process is restarted for the next encoded file. The operation of showing or displaying some or all of the decoded images is shown in FIG. 9 by step 921.

In other embodiments, the reference and the selected residual images are not shown on the display, but may be processed by various means. For example, the reference and the selected residual images may be combined into one image, which may be encoded again for example by a JPEG encoder, and it may be stored in a file located in a storage medium or transmitted to further apparatus.

It shall be appreciated that the term user equipment is intended to cover any suitable type of wireless user equipment, such as mobile telephones, portable data processing devices, portable web browsers, any combination thereof, and/or the like. Furthermore user equipment, universal serial bus (USB) sticks, and modem data cards may comprise apparatus such as the apparatus described in embodiments above.

In general, the various embodiments of the invention may be implemented in hardware or special purpose circuits, software, logic, any combination thereof, and/or the like. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof, and/or the like.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory, any combination thereof, and/or the like. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, any combination thereof, and/or the like.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

As used in this application, the term circuitry may refer to all of the following: (a) hardware-only circuit implementations (such as implementations in only analogue and/or digital circuitry) and (b) to combinations of circuits and software (and/or firmware), such as and where applicable: (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of circuitry applies to all uses of this term in this application, including in any claims. As a further example, as used in this application, the term circuitry would also cover an implementation of merely a processor (or multiple processors) or portion of a processor and its (or their) accompanying software and/or firmware. The term circuitry would also cover, for example and if applicable to the particular claim element, a baseband integrated circuit or applications processor integrated circuit for a mobile phone or a similar integrated circuit in server, a cellular network device, or other network device.

The term processor and memory may comprise but are not limited to in this application: (1) one or more microprocessors, (2) one or more processor(s) with accompanying digital signal processor(s), (3) one or more processor(s) without accompanying digital signal processor(s), (3) one or more special-purpose computer chips, (4) one or more field-programmable gate arrays (FPGAS), (5) one or more controllers, (6) one or more application-specific integrated circuits (ASICS), or detector(s), processor(s) (including dual-core and multiple-core processors), digital signal processor(s), controller(s), receiver, transmitter, encoder, decoder, memory (and memories), software, firmware, RAM, ROM, display, user interface, display circuitry, user interface circuitry, user interface software, display software, circuit(s), antenna, antenna circuitry, and circuitry.

1-46. (canceled)

47. A method comprising:
selecting a first image of a subject with a first image capture parameter and at least one further image of substantially the same subject with at least one corresponding further image capture parameter;
determining at least one feature match image by matching a feature of the at least further image to a corresponding feature of the first image;
generating at least one residual image by subtracting the at least one feature match image from the first image;
encoding the first image and the at least one residual image; and
combining in a file the encoded reference image, the encoded at least one residual image, and information associated with the matching feature.

48. The method as claimed in claim 47, wherein the feature is a statistical based feature, and wherein matching a feature of the further image to a corresponding feature of the first image comprises:
generating a pixel transformation function for the at least one further image by mapping the statistical based feature of the at least one further image to a corresponding statistical based feature of the first image, such that as a result of the mapping the statistical based feature of the at least one further image has substantially the same value as the corresponding statistical based feature of the first image; and
generating the feature match image further comprises using the pixel transformation function to transform pixel values of the at least one non reference image.

49. The method as claimed in claim 48, wherein the statistical based feature is a histogram of pixel level values within an image, wherein the pixel transformation function transforms at least one pixel level value of the further image to a further pixel level value, and wherein the value of the further pixel level value is associated with the histogram of pixel level values of the first image.

50. The method as claimed in claim 49, wherein the pixel transformation function is associated with a direct mapping function between the histogram of the at least one further image and the histogram of the first image.

51. The method as claimed in claim 48, wherein information associated with the matching of the feature of the further image to the corresponding feature of the reference image in a file comprises:
parameters associated with the pixel transformation function.

52. The method according to claim 47, further comprising:
geometrically aligning the at least one feature match image to the first image by using an image registration algorithm, wherein the geometrical alignment is performed before subtracting the at least one feature match image from the first image.

53. The method as claimed in claim 47, wherein combining the at least one encoded residual image, the encoded first image and the information associated with the matching of the feature of the further image to the corresponding feature of the first image in a file comprises:
logically linking at least the at least one encoded residual image and the at least one further encoded image in the file.

54. The method as claimed in claim 47, further comprising capturing the first image and the at least one further image, wherein capturing the first image and the at least one further image comprises capturing the first image and the at least one further image within a period, the period being perceived as a single event.

55. The method as claimed in claim 54 further comprising:
selecting an image capture parameter value for each image to be captured, wherein each image capture parameter comprises at least one of:
exposure time; focus setting; zoom factor; background flash mode; analogue gain; and exposure value; and
inserting a first indicator in the file indicating at least one of the first image capture parameter and the at least one further image capture parameter.

56. An apparatus comprising at least one processor and at least one memory including computer program code the at least one memory and the computer program code configured to, with the at least one processor, cause the apparatus at least to:
select a first image of a subject with a first image capture parameter and at least one further image of substantially the same subject with at least one corresponding further image capture parameter;
determine at least one feature match image by matching a feature of the at least further image to a corresponding feature of the first image;
generate at least one residual image by subtracting the at least one feature match image from the first image;
encode the first image and the at least one residual image; and
combine in a file the encoded reference image, the encoded at least one residual image, and information associated with the matching feature.

57. The apparatus as claimed in claim 56, wherein the feature is a statistical based feature, and wherein matching a feature of the further image to a corresponding feature of the first image causes the apparatus to:
generate a pixel transformation function for the at least one further image by mapping the statistical based feature of the at least one further image to a corresponding statistical based feature of the first image, such that as a result of the mapping the statistical based feature of the at least one further image has substantially the same value as the corresponding statistical based feature of the first image; and
generate the feature match image further causes the apparatus to perform using the pixel transformation function to transform pixel values of the at least one non reference image.

58. The apparatus as claimed in claim 57, wherein the statistical based feature is a histogram of pixel level values within an image, wherein the pixel transformation function causes the apparatus to transform at least one pixel level value of the further image to a further pixel level value, and wherein the value of the further pixel level value is associated with the histogram of pixel level values of the first image.

59. The apparatus as claimed in claim 58, wherein the pixel transformation function is associated with a direct mapping function between the histogram of the at least one further image and the histogram of the first image.

60. The apparatus as claimed in claim 57, wherein information associated with the matching of the feature of the further image to the corresponding feature of the reference image in a file comprises:
parameters associated with the pixel transformation function.

61. The apparatus according to claim 56, further caused to:
geometrically align the at least one feature match image to the first image by using an image registration algorithm, wherein the geometrical alignment is performed before subtracting the at least one feature match image from the first image.

62. The apparatus as claimed in claim 56, wherein the apparatus being caused to combine the at least one encoded residual image, the encoded first image and the information associated with the matching of the feature of the further image to the corresponding feature of the first image in a file causes the apparatus to:
logically link at least the at least one encoded residual image and the at least one further encoded image in the file.

63. The apparatus as claimed in claim 56, further caused to capture the first image and the at least one further image, wherein the apparatus being caused to capture the first image and the at least one further image further causes the apparatus to capture the first image and the at least one further image within a period, the period being perceived as a single event.

64. The apparatus as claimed in claim 63, further caused to:
select an image capture parameter value for each image to be captured, wherein each image capture parameter comprises at least one of: exposure time; focus setting; zoom factor; background flash mode; analogue gain; and exposure value; and
insert a first indicator in the file indicating at least one of the first image capture parameter and the at least one further image capture parameter.

65. A method comprising:
decoding an encoded first image and at least one encoded residual image composed of the encoded difference between the first image and a feature match image, contained in a file, wherein the feature match image is a further image which has been determined by matching a feature of at least one second image to a corresponding feature of the first image;
subtracting the at least one decoded residual image from the decoded first image to generate the at least one feature match image; and
transforming the at least one feature match image to generate at least one further image.

66. The method as claimed in claim 65, wherein the first image is of a subject with a first image capture parameter, and the at least one further image is substantially the same subject with at least one further image capture parameter.

67. The method as claimed in claim 65, wherein the feature is a statistical based feature and a value of the statistical based feature of the at least one feature match image is substantially the same as a value of the statistical based feature of the first image, and wherein transforming the feature match image comprises:
using a pixel transformation function to transform pixel level values of the at least one feature match image, wherein the transformation function comprises mapping the statistical based feature of the at least one feature match image from the corresponding statistical based feature of the first image, such that the value of the statistical based feature of the at least one feature match image differs from the value of the statistical based feature of the reference image.

68. The method as claimed in claim 67, wherein the statistical based feature is a histogram of pixel level values within an image, wherein the pixel transformation function transforms at least one pixel level value of the at least one feature match image to a further pixel level value, and wherein the further pixel level value is associated with a histogram of pixel level values of the at least one further image.

69. The method as claimed in claim 67, wherein the pixel transformation function is associated with an inverse of a mapping function between the histogram of the at least one feature match image and the histogram of the first image.

70. The method as claimed in claim 67, wherein the file further comprises the pixel transformation function.

71. An apparatus comprising at least one processor and at least one memory including computer program code the at least one memory and the computer program code configured to, with the at least one processor, cause the apparatus at least to:
decode an encoded first image and at least one encoded residual image composed of the encoded difference between the first image and a feature match image, contained in a file, wherein the feature match image is a further image which has been determined by matching a feature of at least one further image to a corresponding feature of the first image;
subtract the at least one decoded residual image from the decoded first image to generate the at least one feature match image; and
transform the at least one feature match image to generate at least one further image.

72. The apparatus as claimed in claim 71, wherein the first image is of a subject with a first image capture parameter, and the at least one further image is substantially the same subject with at least one further image capture parameter.

73. The apparatus as claimed in claim 71, wherein the feature is a statistical based feature and a value of the statistical based feature of the at least one feature match image is substantially the same as a value of the statistical based feature of the first image, and wherein the apparatus being caused to transform the feature match image causes the apparatus to:
use a pixel transformation function to transform pixel level values of the at least one feature match image, wherein the transformation function comprises mapping the statistical based feature of the at least one feature match image from the corresponding statistical based feature of the first image, such that the value of the statistical based feature of the at least one feature match image differs from the value of the statistical based feature of the reference image.

74. The apparatus as claimed in claim 73, wherein the statistical based feature is a histogram of pixel level values within an image, the pixel transformation function causes the apparatus to transform at least one pixel level value of the at least one feature match image to a further pixel level value, and wherein the further pixel level value is associated with a histogram of pixel level values of the at least one further image.

75. The apparatus as claimed in claim 73, wherein the pixel transformation function is associated with an inverse of a mapping function between the histogram of the at least one feature match image and the histogram of the first image

76. The apparatus as claimed in claim 73, wherein the file further comprises the pixel transformation function.
